(19) United States
(12) Patent Application Publication
(10) Pub. No.: US 2014/0241724 A1
(43) Pub. Date: Aug. 28, 2014

(54) Transmission Prioritization Based on Polling Time

(71) Applicant: FUTUREWEI TECHNOLOGIES, INC., PLANO, TX (US)

(72) Inventors: Michael P. McGarry, El Paso, TX (US); Yuanqiu Luo, Cranbury, NJ (US)

(73) Assignee: FUTUREWEI TECHNOLOGIES, INC., PLANO, TX (US)

(21) Appl. No.: 14/191,233

(22) Filed: Feb. 26, 2014

Related U.S. Application Data
(60) Provisional application No. 61/770,235, filed on Feb. 27, 2013.

(51) Int. Cl. H04B 10/27; H04J 14/08; H04L 12/911; H04B 10/40

(52) U.S. Cl. CPC H04B 10/271; H04B 10/40; H04J 14/086; H04L 47/826
USPC 398/67

(57) ABSTRACT

An apparatus comprises a receiver configured to receive a plurality of instructions, a plurality of first messages, and a plurality of second messages, a processor coupled to the receiver and configured to process the instructions, the first messages, and the second messages, and a transmitter coupled to the processor and configured to transmit the second messages based on the instructions, wherein the instructions instruct the processor to transmit the second messages based on polling times. An apparatus comprises a processor configured to compile instructions, wherein the instructions instruct prioritizing of data transmissions based on propagation delays, and a transmitter coupled to the processor and configured to transmit the instructions.

### CROSS-REFERENCE TO RELATED APPLICATIONS

This application claims priority to U.S. provisional patent application No. 61/770,235 filed Feb. 27, 2013 by Michael P. McGarry, et al., and titled “Customer Premises Equipment Transmission Ordering to Minimize Polling Time for Hybrid Fiber/Copper Access Networks,” which is incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A passive optical network (PON) is one system for providing network access over “the last mile.” The PON is a point-to-multi-point (P2MP) network comprised of an optical line terminal (OLT) at the central office, an optical distribution network (ODN), and a plurality of optical network units (ONUs) at the customer premises. Ethernet passive optical network (EPON) is a PON standard developed by the Institute of Electrical and Electronics Engineers (IEEE) and is specified in IEEE 802.3ah, which is incorporated by reference. In EPON, a single fiber may be used for both downstream transmission (i.e., from the OLT to the ONUs) and upstream transmission (i.e., from the ONUs to the OLT) by using different wavelengths. The OLT may implement an EPON media access control (MAC) layer for transmission of Ethernet frames. Multi-point control protocol (MPCP) may be implemented for bandwidth assignment, bandwidth polling, auto-discovery, and ranging. Ethernet frames may be broadcast downstream based on a logical link identifier (LLID) embedded in a preamble frame. Upstream bandwidth may be assigned based on polling, which may refer to arbitration of access to a network, particularly bandwidth assignment.

Hybrid networks may employ two main stages, a first optical/fiber stage and a second electrical/copper stage. The second electrical/copper stage may be, for instance, coaxial (coax) or twisted pair. Ethernet over Coax (EoC) may be a generic name used to describe all technologies that transmit Ethernet frames over such a hybrid network. EoC technologies may include EPON Protocol over Coax (EPoC), Data over Cable Service Interface Specification (DOCSIS), Multimedia over Coax Alliance (MoCA), G.hn (a common name for a home network technology family of standards developed under the International Telecommunication Union (ITU) and promoted by the HomeGrid Forum), Home Phoneline Networking Alliance (HPNA), and Home Plug Audio/Visual (A/V). EoC technologies may be adapted to run outdoor coax access from an ONU to an EoC head end with connected customer premises equipment (CPEs) located in subscribers' homes. There is a rising demand for EPoC, which may provide for the use of EPON as an access system to interconnect with multiple coaxial cables to terminate coaxial network units (CNUs) located in subscribers' homes.

### SUMMARY

In one embodiment, the disclosure includes an apparatus comprising a receiver configured to receive a plurality of instructions, a plurality of first messages, and a plurality of second messages, a processor coupled to the receiver and configured to process the instructions, the first messages, and the second messages, and a transmitter coupled to the processor and configured to transmit the second messages based on the instructions, wherein the instructions instruct the processor to transmit the second messages based on polling times.

In another embodiment, the disclosure includes an apparatus comprising a processor configured to compile instructions, wherein the instructions instruct prioritizing of data transmissions based on propagation delays, and a transmitter coupled to the processor and configured to transmit the instructions.

In yet another embodiment, the disclosure includes a method comprising receiving a plurality of instructions for prioritizing data transmissions, processing the instructions, receiving the data transmissions, and transmitting the data transmissions based on the instructions, wherein the instructions instruct prioritizing of the data transmissions so that one of the data transmissions associated with a shortest polling time is transmitted first.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a hybrid optical-electrical network.

FIG. 2 is a schematic diagram of a hybrid optical-electrical network according to an embodiment of the disclosure.

FIG. 3 is a polling timing diagram for the drop point of FIG. 2 according to an embodiment of the disclosure.

FIG. 4 is a polling timing diagram for the drop point and one of the CPEs of FIG. 2 according to an embodiment of the disclosure.

FIG. 5 is a polling timing diagram for the drop point and two of the CPEs of FIG. 2 according to an embodiment of the disclosure.

FIG. 6 is a flowchart illustrating a method of prioritizing data transmissions according to an embodiment of the disclosure.

FIG. 7 is a schematic diagram of a computer system according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

When a network endpoint, such as a CPE, first accesses the network, the OLT may begin with the CPE an initialization procedure, which may include polling. In addition to when a CPE first accesses the network, the OLT may poll the CPE at any other time the OLT desires. Polling may comprise the OLT sending to the CPE a gate message, or transmission access message, which may be a request for the CPE's bandwidth requirement and other information; the CPE checking its queue for that information; the CPE sending to the OLT an upstream transmission window, which may comprise packets that include a report message with the CPE's bandwidth requirement, as well as user data; and the OLT sending to the CPE the OLT's bandwidth assignment. Generally, a polling time may refer to the total time for those events to occur, in other words, the round trip time of the messages, the processing time at the OLT and the CPE, and the queuing time at the CPE. Specifically, the polling time may refer to the total time from the initiation of polling signaling from the OLT to the time the first bit transmitted from an intermediate node is received at the OLT. In some networks, multiple CPEs may be connected in parallel. When those networks implement a time division multiple access (TDMA) scheme, it may be necessary to schedule the order which the CPEs transmit in both the polling process and subsequent transmissions.

Existing transmission ordering, or prioritizing, schemes may order CPE transmissions based on CPE registration time, a random order, class, or other criteria. A scheme based on CPE registration time may assign priority to the CPEs who first register with the OLT. A scheme based on a random order may subject the CPEs to a randomizing algorithm and assign priority to the CPEs according to the results of that algorithm. A scheme based on class may assign highest priority to emergency calls in one class and other, lower priorities to non-emergency calls in other classes. The above schemes and other known schemes may be combined in a complementary scheme. The above schemes and other schemes do not, however, necessarily assign transmission order in a way that reduces polling time, reduces buffering time at the intermediate node, improves channel utilization, or otherwise improves network efficiency.

Disclosed herein is a CPE transmission ordering scheme that may reduce polling time, reduce buffering time at the intermediate node, improve channel utilization, and otherwise improve network efficiency. The scheme may apply to hybrid optical-electrical networks such as EoCs, as well as other hybrid or staged networks that employ TDMA or other transmission ordering techniques. The scheme may assign CPE transmission ordering based on polling time so that a CPE with the shortest polling time may transmit first, a CPE with the longest polling time may transmit last, and so on. Transmissions may also be ordered by class so that, for instance, emergency calls are ordered according to polling time and transmitted first and non-emergency calls are ordered according to polling time and transmitted second. The scheme may be implemented at an MAC or other layer.

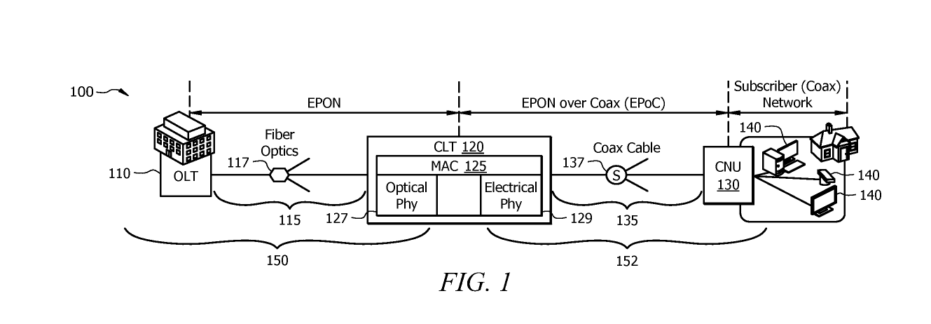

FIG. 1 is a schematic diagram of a hybrid optical-electrical network 100. The network 100 may generally comprise an optical portion 150 and an electrical (e.g., coax or twisted pair) portion 152. The network 100 may specifically comprise an OLT 110, a CNU 130 coupled to subscriber devices 140, and a coax line terminal (CLT) 120 positioned between the OLT 110 and the CNU 130, e.g., between the optical portion 150 and the electrical portion 152. The OLT 110 may be coupled to the CLT 120 via an ODN 115. The ODN 115 may comprise fiber optics and an optical splitter 117 that may couple the OLT 110 to the CLT 120. The CLT 120 may be coupled to the CNUs 130 via an electrical distribution network (EDN) 135, which may comprise a cable splitter 137. Although FIG. 1 shows one CLT 120, one CNU 130, and two subscriber devices 140, the network 100 may comprise any number of CLTs 120, CNUs 130, and subscriber devices 140 in, for instance, branching configurations. The components of the network 100 may be arranged as shown in FIG. 1 or in any other suitable arrangement.

The optical portion 150 may be similar to a PON in that it may be a communications network that does not require any active components to distribute data between the OLT 110 and the CLT 120. Instead, the optical portion 150 may use the passive optical components in the ODN 115 to distribute data between the OLT 110 and the CLT 120. Examples of suitable protocols that may be implemented in the optical portion 150 include asynchronous transfer mode PON (APON) and broadband PON (BPON) defined by The International Telecommunication Union (ITU) Telecommunication Standardization Sector (ITU-T) G.983 standard, gigabit-capable PON (GPON) defined by the ITU-T G.984 standard, EPON defined by IEEE 802.3ah standard, and wavelength-division multiplexing (WDM) PON (WDM-PON), which are incorporated by reference.

The OLT 110 may be any device configured to communicate with the CNU 130 via the CLT 120. The OLT 110 may act as an intermediary between the CLT 120 or the CNU 130 and another network (not shown). The OLT 110 may forward data received from the other network to the CLT 120 or the CNU 130 and forward data received from the CLT 120 or the CNU 130 to the other network. Although the specific configuration of the OLT 110 may vary depending on the type of optical protocol implemented in the optical portion 150, the OLT 110 may comprise an optical transmitter and an optical receiver. When the other network is using a network protocol that is different from the protocol used in the optical portion 150, the OLT 110 may comprise a converter that converts the other network protocol into the optical portion 150 protocol. The OLT converter may also convert the optical portion 150 protocol into the other network protocol.

The ODN 115 may be a data distribution system that may comprise optical fiber cables, couplers, splitters, distributors, and other equipment. The optical fiber cables, couplers, splitters, distributors, and other equipment may be passive optical components. Specifically, the optical fiber cables, couplers, splitters, distributors, and other equipment may be components that do not require any power to distribute data signals between the OLT 110 and the CLT 120. The optical fiber cables may be replaced by any optical transmission media. The ODN 115 may comprise one or more optical amplifiers. The ODN 115 may typically extend from the OLT 110 to the CLT 120 and any optional ONUs (not shown) in a branching configuration as shown in FIG. 1 or in any other suitable arrangement.

The CLT 120 may be any device or component configured to forward downstream data from the OLT 110 to the CNU 130 and forward upstream data from the CNU 130 to the OLT 110. The CLT 120 may convert the downstream and upstream data appropriately to transfer the data between the optical portion 150 and the electrical portion 152. The data transferred over the ODN 115 may be transmitted or received in the form of optical signals, and the data transferred over the EDN 135 may be transmitted or received in the form of electrical signals that may or may not have the same logical structure as the optical signals. The CLT 120 may encapsulate or frame the data in the optical portion 150 and the electrical portion 152 differently. The CLT 120 may include a MAC layer 125 and a physical (PHY) layer, the latter corresponding to the type of signals carried over the respective media. The MAC layer 125 may provide addressing and channel access control services to the PHY layers. The PHY layers may comprise an optical PHY 127 and an electrical PHY 129. The CLT 120 may be transparent to the CNU 130 and the OLT 110 in that the frames sent from the OLT 110 to the CNU 130 may be directly addressed to the CNU 130 (e.g. in the destination address), and vice-versa. As such, the CLT 120 may intermediate between the optical portion 150 and the electrical portion 152. The CLT 120 may also be referred to as a fiber-coaxial unit (FCU).

The electrical portion 152 may be similar to any known electrical communication system. The electrical portion 152 may also be referred to as a copper portion or an electrical portion. The electrical portion 152 may not require any active components to distribute data between the CLT 120 and the CNU 130. Instead, the electrical portion 152 may use passive electrical components in the electrical portion 152 to distribute data between the CLT 120 and the CNU 130. Alternatively, the electrical portion 152 may use some active components, such as amplifiers. Examples of suitable protocols that may be implemented in the electrical portion 152 include MoCA, G.hn (a common name for a home network technology family of standards developed under ITU and promoted by the HomeGrid Forum), HPNA, Home Plug AV, very-high-bit-rate digital subscriber line 2 (VDSL2), and G.fast, which are incorporated by reference.

The EDN 135 may be a data distribution system that may comprise electrical cables (e.g., coaxial cables and twisted wires), couplers, splitters, distributors, and other equipment. The electrical cables, couplers, splitters, distributors, and other equipment may be passive electrical components. Specifically, the electrical cables, couplers, splitters, distributors, or other equipment may be components that do not require any power to distribute data signals between the CLT 120 and the CNU 130. It should be noted that the electrical cables may be replaced by any electrical transmission media. The EDN 135 may comprise one or more electrical amplifiers. The EDN 135 may extend from the CLT 120 to the CNU 130 in a branching configuration as shown in FIG. 1 or in any other suitable arrangement.

The CNU 130 may be any device configured to communicate with the OLT 110, the CLT 120, and any subscriber devices 140. Specifically, the CNU 130 may act as an intermediary between the CLT 120 and the subscriber devices 140. For instance, the CNU 130 may forward data received from the CLT 120 to the subscriber devices 140 and forward data received from the subscriber devices 140 to the OLT 110. Although the specific configuration of the CNU 130 may vary depending on the configuration of the network 100, the CNU 130 may comprise an electrical transmitter configured to send electrical signals to the CLT 120 and an electrical receiver configured to receive electrical signals from the CLT 120. Additionally, the CNU 130 may comprise a converter that converts the electrical signal into electrical signals for the subscriber devices 140, such as signals in the asynchronous transfer mode (ATM) protocol, and a second transmitter or receiver that may send or receive the electrical signals to the subscriber devices 140. The CNU 130 may also be referred to as a coaxial network terminal (CNT). The CNU 130 may be located at distributed locations, such as the customer premises, but may be at other locations as well.

The subscriber devices 140 may be any devices configured to interface with a user or a user device. For example, the subscriber devices 140 may include desktop computers, laptop computers, tablets, mobile telephones, residential gateways, televisions, set-top boxes, and similar devices.

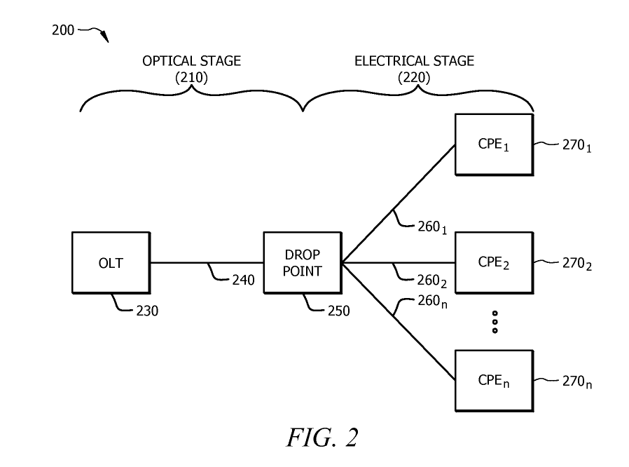

FIG. 2 is a schematic diagram of a hybrid optical-electrical network 200 according to an embodiment of the disclosure. The network may generally comprise two stages, an optical stage 210 and an electrical stage 220. The network may be similar to the network 100. In particular, an OLT 230 may be similar to the OLT 110, a drop point 250 may be similar to the CLT 120, and CPEs₁₋ₙ 270₁₋ₙ may be similar to the CNU 130. The drop point 250 may comprise an ONU and a digital subscriber line access multiplexer (DSLAM) and may also be referred to as a bridging device. As shown, the CPEs₁₋ₙ 270₁₋ₙ may connect to the drop point 250 via parallel transmission channels₁₋ₙ 260₁₋ₙ, which may be coaxial cables, and to the OLT 230 via a shared transmission channel 240, which may be an optical fiber.

When one of the CPEs₁₋ₙ 270₁₋ₙ, for instance the CPE₁ 270₁, connects to the network 200 or whenever the OLT 230 otherwise desires, polling may begin. There may be two stages of polling. In a first stage, the OLT 230 may poll the drop point 250. In a second stage, the drop point 250 may poll the CPEs₁₋ₙ 270₁₋ₙ. The order in which the CPEs₁₋ₙ 270₁₋ₙ transmit upstream may affect polling time.

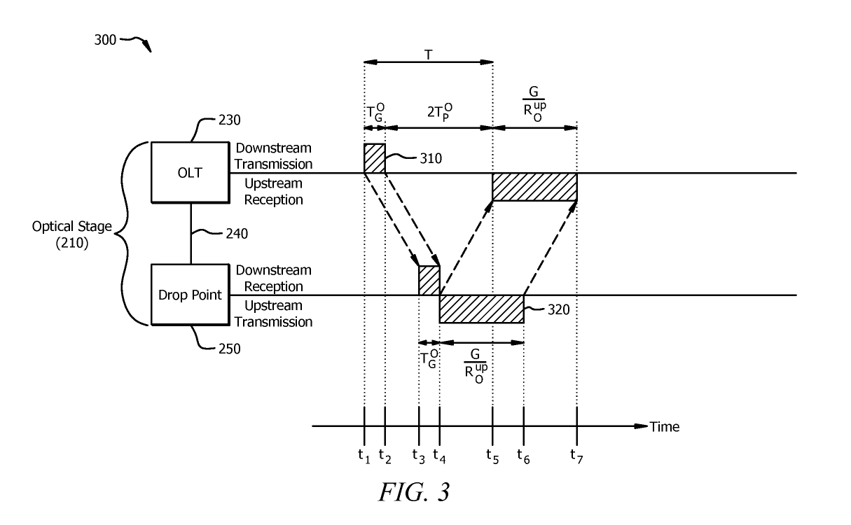

FIG. 3 is a polling timing diagram 300 for the drop point 250 of FIG. 2 according to an embodiment of the disclosure. The diagram 300 may demonstrate the first stage of polling mentioned above. At times t₁ and t₂, the OLT 230 may begin and end, respectively, transmission of a gate message 310 to the drop point 250 downstream in the optical stage 210. The times such as t₁ and t₂ may be in seconds (s). The total time from t₁ to t₂ may be T_{G}^{O}. The gate message 310 may indicate an upstream transmission window start time and size, the latter of which may be in bits and represented as G. The OLT 230 or another suitable device in the network 200 may assign the upstream transmission window size. At times t₃ and t₄, the drop point 250 may begin and end, respectively, reception of the gate message 310. The total time from t₃ to t₄ may also be T_{G}^{O}. A propagation delay for the gate message 310 from the OLT 230 to the drop point 250 over the shared transmission channel 240 of the optical stage 210 may be T_{P}^{O}.

After receiving the gate message 310, the drop point 250 may prepare an upstream transmission window 320 in response to the gate message 310. At times t₄ and t₆, the drop point 250 may begin and end, respectively, transmission of the upstream transmission window 320 to the OLT 230 upstream in the optical stage 210. The total time from t₄ to t₆ may be

$$\frac{G}{{R}_{O}^{up}} ,$$

where R_{O}^{up} is a transmission rate of the optical stage 210 in the upstream direction in bits per second (bps). A propagation delay for the upstream transmission window 320 from the drop point 250 to the OLT 230 over the shared transmission channel 240 in the optical stage 210 may also be T_{P}^{O}. As a result, the total time from t₂ to t₅ may be 2T_{P}^{O}. At times t₅ and t₇, the OLT 230 may begin and end, respectively, reception of the upstream transmission window 320 from the drop point 250. The total time from t₅ to t₇ may also be

$$\frac{G}{{R}_{O}^{up}} .$$

As can be seen, the upstream transmission window 320 may be bigger, and may therefore take longer to transmit and receive, than the gate message 310. Because of the size of the upstream transmission window 320, the OLT 230 may begin receiving the upstream transmission window 320 before the drop point 250 ends transmitting the upstream transmission window 320. A polling time, T, may be defined by the following equation:

T=T_{G}^{O}+2T_{P}^{O}. (1)

Though T may include T_{G}^{O}, the time for the OLT 230 to transmit the gate message 310, T may not include

$$\frac{G}{{R}_{O}^{up}} ,$$

the time for the OLT 230 to receive the upstream transmission window 320, because, as described above, T may be defined as ending when the first bit transmitted from an intermediate node, in this case the drop point 250, is received at the OLT, in this case the OLT 230.

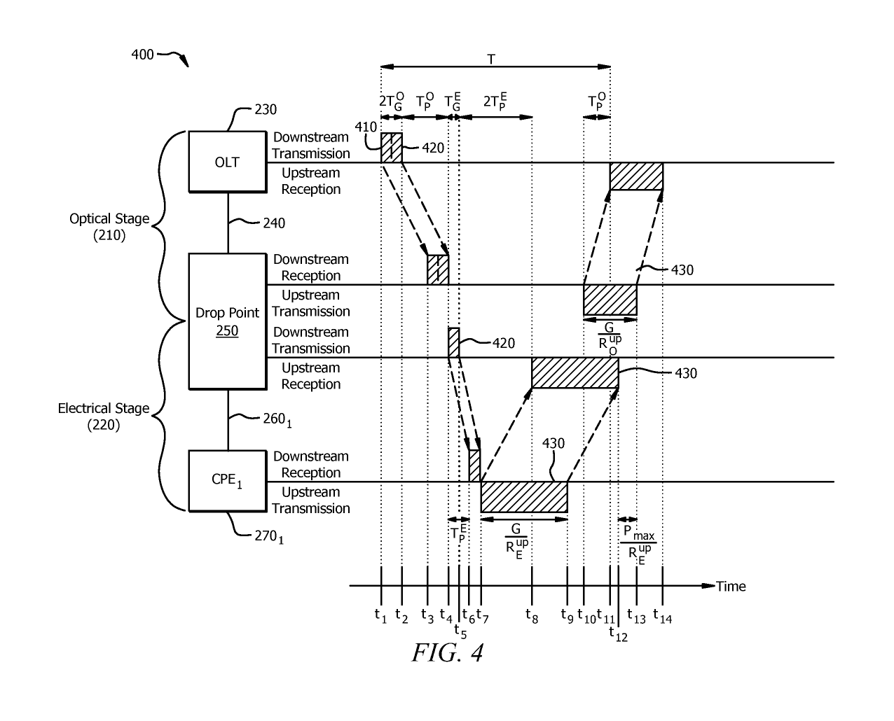

FIG. 4 is a polling timing diagram 400 for the drop point 250 and one of the CPEs₁₋ₙ 270₁₋ₙ of FIG. 2 according to an embodiment of the disclosure. In particular, the diagram 400 may be for the drop point 250 and the CPE₁ 270₁. The diagram 400 may have components drawn to different scales in order to emphasize aspects of the diagram 400. The diagram 400 may demonstrate the first stage and second stage of polling mentioned above. At times t₁ and t₂, the OLT 230 may begin and end, respectively, transmission of two gate messages to the drop point 250 downstream in the optical stage 210. The two gate messages may comprise a first gate message 410 for the drop point 250 and a second gate message 420 for the CPE₁ 270₁. The first gate message 410 may indicate for the optical stage 210 an upstream transmission window size (in bits), which may be G, and the second gate message 420 may indicate for the electrical stage 220 an upstream transmission window size (in bits), which may also be G. The first gate message 410 and the second gate message 420 may each take a time, T_{G}^{O}, to transmit, so the total time from t₁ to t₂ may be 2T_{G}^{O}. At times t₃ and t₄, the drop point 240 may begin and end, respectively, reception of the first gate message 410 and the second gate message 420. The total time from t₃ to t₄ may also be 2T_{G}^{O}. A propagation delay for the first gate message 410 and the second gate message 420 from the OLT 230 to the drop point 250 over the shared transmission channel 240 may be T_{P}^{O}.

At times t₄ and t₅, the drop point 250 may begin and end, respectively, transmission of the second gate message 420 to the CPE₁ 270₁ downstream in the electrical stage 220. The total time from t₄ to t₅ may be T_{G}^{E}, which may be longer than T_{G}^{O}, because the parallel transmission channel₁ 260₁ in the electrical stage 220 may be slower than the shared transmission channel 240 in the optical stage 210. At times t₆ and t₇, the CPE₁ 270₁ may begin and end, respectively, reception of the second gate message 420. The total time from t₆ to t₇ may also be T_{G}^{E}. A propagation delay for the second gate message 420 from the drop point 250 to the CPE₁ 270₁ over the parallel transmission channel₁ 260₁ may be T_{P}^{E}.

After receiving the second gate message 420, the CPE₁ 270₁ may prepare an upstream transmission window 430. At times t₇ and t₉, the CPE₁ 270₁ may begin and end, respectively, transmission of the upstream transmission window 430 upstream to the drop point 250. The total time from t₇ to t₉ may be

$$\frac{G}{{R}_{E}^{up}} ,$$

where G is an upstream transmission window size (in bits) and R_{E}^{up} is a transmission rate of the electrical stage 220 in the upstream direction. A propagation delay for the upstream transmission window 430 from the CPE₁ 270₁ to the drop point 250 over the parallel transmission channel₁ 260₁ in the electrical stage 220 may also be T_{P}^{E}. At times t₈ and t₁₂, the drop point 250 may begin and end, respectively, reception of the upstream transmission window 430 over the parallel transmission channel₁ 260₁ in the electrical stage 220. The total time from t₈ to t₁₂ may also be

$$\frac{G}{{R}_{E}^{up}} .$$

As can be seen, the upstream transmission window 430 may be bigger, and may therefore take longer to transmit and receive, than the second gate message 420. Because of the size of the upstream transmission window 430, the drop point 250 may begin receiving the upstream transmission window 430 before the CPE₁ 270₁ ends transmitting the upstream transmission window 430.

At times t₁₀ and t₁₃, the drop point 250 may begin and end, respectively, transmission of the upstream transmission window 430 to the OLT 230 upstream in the optical stage 210. The total time from t₁₀ to t₁₃ may be

$$\frac{G}{{R}_{O}^{up}} ,$$

where R^{O}ᵤₚ is a transmission rate of the optical stage 210 in the upstream direction.

$$\frac{G}{{R}_{O}^{up}}$$

may be shorter than because

$$\frac{G}{{R}_{E}^{up}}$$

the shared transmission channel 240 in the optical stage 210 may be faster than the parallel transmission channel₁ 260₁ in the electrical stage 220. At times t₁₁ and t₁₄, the OLT 230 may begin and end, respectively, reception of the upstream transmission window 430. The total time from t₁₁ to t₁₄ may also be

$$\frac{G}{{R}_{O}^{up}} .$$

A propagation delay for the upstream transmission window 430 from the drop point 250 to the OLT 230 over the shared transmission channel 240 may also be T_{P}^{O}.

The drop point 250 may begin uninterrupted transmission of the upstream transmission window 430 in the optical stage 210 if each individual packet in the upstream transmission window 430 received in the electrical stage 220 is received at the drop point 250 before that same packet is transmitted in the upstream transmission window 430 in the optical stage 210. To ensure that condition, the following inequality must hold:

$${t}_{7} + \frac{( G + {P}_{max} )}{{R}_{E}^{up}} + {T}_{P}^{E} \leq {t}_{10} + \frac{G}{{R}_{O}^{up}} , \qquad ( 2 )$$

where t₇ is a time that the CPE₁ 270₁ begins transmission of the upstream transmission window 430; Pₘₐₓ is a maximum packet size; t₁₀ is a time that the drop point 250 begins transmission of the upstream transmission window 430 upstream to the OLT 230 in the optical stage 210; and G, R_{E}^{up}, T_{P}^{E}, and R^{O}ᵤₚ are defined above. Rearranging inequality 2 provides the following:

$${t}_{10} \geq {t}_{7} + {T}_{P}^{E} + \frac{G}{{R}_{E}^{up}} - \frac{( G - {P}_{max} )}{{R}_{O}^{up}} . \qquad ( 3 )$$

A polling time, T, may be represented by the following equation:

$$T = 2 {T}_{G}^{O} + {T}_{P}^{O} + {T}_{G}^{E} + 2 {T}_{P}^{E} + \frac{G}{{R}_{E}^{up}} - \frac{( G - {P}_{max} )}{{R}_{O}^{up}} + {T}_{P}^{O} . \qquad ( 4 )$$

Rearranging equation 4 provides the following equation:

$$T = ( 2 {T}_{G}^{O} + {T}_{G}^{E} ) + 2 ( {T}_{P}^{O} + {T}_{P}^{E} ) + [ \frac{G}{{R}_{E}^{up}} - \frac{G}{{R}_{O}^{up}} + \frac{{P}_{max}}{{R}_{O}^{up}} ] . \qquad ( 5 )$$

In equation 5, the terms grouped in the first set of parentheses may represent the total time it takes to transmit downstream the first gate message 410 and the second gate message 420, the terms grouped in the second set of parentheses may represent the total propagation delays, and the terms grouped in the brackets may represent the total time it takes to transmit the upstream transmission window 430.

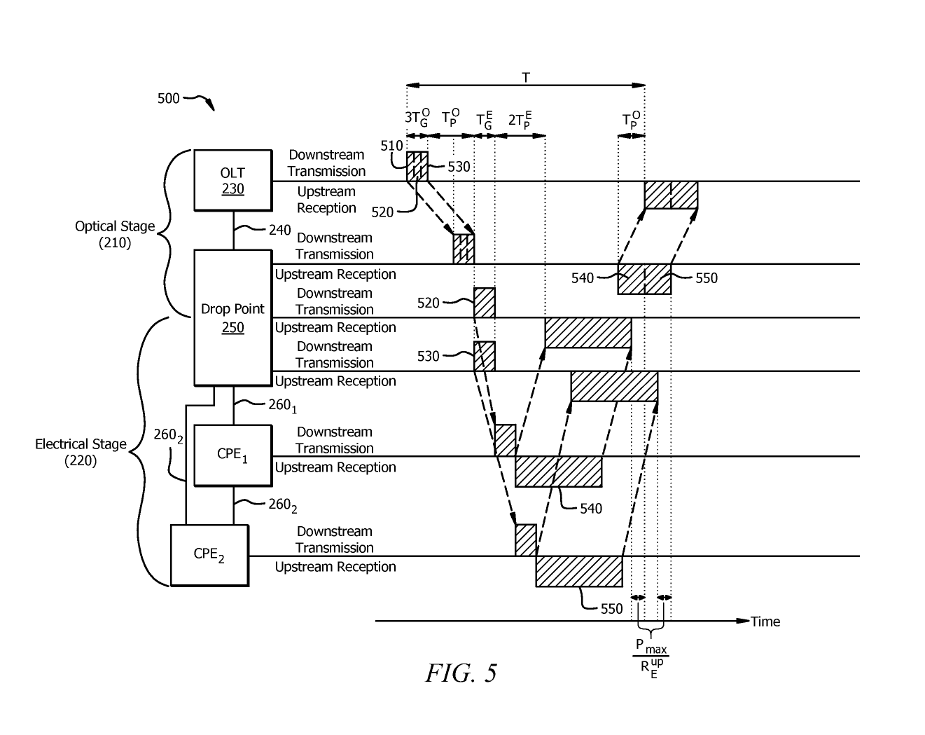

FIG. 5 is a polling timing diagram 500 for the drop point 250 and two of the CPEs₁₋ₙ 270₁₋ₙ of FIG. 2 according to an embodiment of the disclosure. In particular, the diagram 500 may be for the drop point 250, the CPE₁ 270₁, and the CPE₂ 270₂. Similar to the diagram 400, the diagram 500 may include for the drop point 250 a first gate message 510, which may be similar to the first gate message 410; for the CPE₁ 270₁ a second gate message 520, which may be similar to the second gate message 420; and for the CPE₁ 270₁ a first upstream transmission window 540, which may be similar to the upstream transmission window 430. The diagram 500 may, however, also include for the CPE₂ 270₂ a third gate message 530 and a second upstream transmission window 550. Accordingly, a polling time, T, may be represented by the following equation:

$$T = ( 1 + 2 ) {T}_{G}^{O} + {T}_{G}^{E} + 2 {T}_{P}^{O} + max [ 2 {T}_{{P}_{1}}^{E} + \frac{{G}_{1}}{{R}_{E}^{up}} - \frac{{G}_{1}}{{R}_{O}^{up}} , 2 {T}_{{P}_{2}}^{E} + \frac{{G}_{2}}{{R}_{E}^{up}} - \frac{( {G}_{1} + {G}_{2} )}{{R}_{O}^{up}} ] + \frac{{P}_{max}}{{R}_{O}^{up}} , \qquad ( 6 )$$

where T_{P}_{₁}^{E} may be a propagation delay from the drop point 250 to the CPE₁ 270₁ over the parallel transmission channel₁ 260₁, G₁ may be a grant window size for the CPE₁ 270₁, T_{P}_{₂}^{E} may be a propagation delay from the drop point 250 to the CPE₂ 270₂ over the parallel transmission channel₂ 260₂, and G₂ may be a grant window size for the CPE₁ 270₁. When looking at equation 6, the following inequality can be seen to minimize T:

$$2 {T}_{{P}_{2}}^{E} + \frac{{G}_{2}}{{R}_{E}^{up}} > 2 {T}_{{P}_{1}}^{E} + \frac{{G}_{1}}{{R}_{E}^{up}} . \qquad ( 7 )$$

As can be seen, when polling multiple CPEs, the CPE whose propagation delay plus grant window size is largest should be polled last. Generalizing equation 6 to n CPEs produces the following equation:

$$T = ( 1 + n ) {T}_{G}^{O} + {T}_{G}^{E} + 2 {T}_{P}^{O} + {max}_{i = 1 - n} [ 2 {T}_{{P}_{i}}^{E} + \frac{{G}_{i}}{{R}_{E}^{up}} - \frac{{\sum }_{j = 1}^{i} {G}_{j}}{{R}_{O}^{up}} ] + \frac{{P}_{max}}{{R}_{O}^{up}} . \qquad ( 8 )$$

When looking at equation 8, it can be seen that CPE transmissions should be ordered in ascending order according to the following expression:

$$2 {T}_{{P}_{i}}^{E} + \frac{{G}_{i}}{{R}_{E}^{up}} . \qquad ( 9 )$$

FIGS. 3-5 show that, when the OLT 230 is able to determine expression 9 for each of the CPEs₁₋ₙ 270₁₋ₙ, the OLT 230 may prioritize all subsequent upstream transmission windows of the CPEs₁₋ₙ 270₁₋ₙ. The OLT 230 may already know T_{P}_{ᵢ}^{E} for each of the CPEs₁₋ₙ 270₁₋ₙ and may know and R_{E}^{up}, for instance based on prior messaging, so the OLT 230 may be able to determine expression 9 for each of the CPEs₁₋ₙ 270₁₋ₙ, upon assigning Gᵢ for each of the CPEs₁₋ₙ 270₁₋ₙ. After determining expression 9 for each of the CPEs₁₋ₙ 270₁₋ₙ, the OLT 230 may prioritize the upstream transmission windows according to expression 9. The OLT 230 may inform the drop point 250 and the CPEs₁₋ₙ 270₁₋ₙ of the prioritization via the window start times in the gate messages. The prioritization may not occur in the electrical stage 220 because the parallel transmission channels₁₋ₙ 260₁₋ₙ may be parallel to each other and therefore not require timed access, but the prioritization may occur in the optical stage 210 because the shared transmission channel 240 may require timed access. The prioritizing of upstream transmission windows may be maintained for a granting cycle. Subsequent granting cycles may have different prioritizations based on new polling. The OLT 230 or another node may instruct the drop point 250 to perform the described ordering and may do so in a MAC layer message. The ordering may also be based on class. For example, all emergency messages may be given priority over all non-emergency messages. The emergency and non-emergency messages may then be ordered within their respective groups based on polling time.

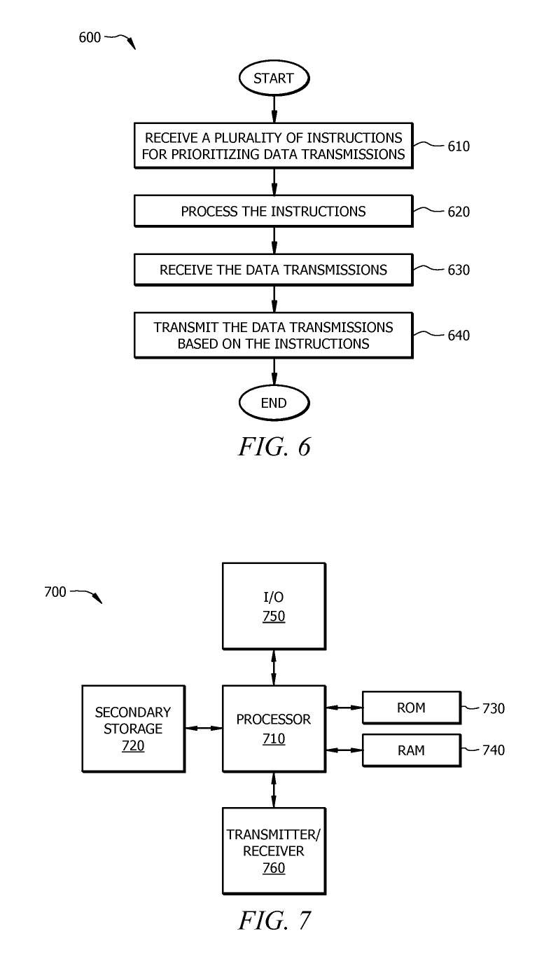

FIG. 6 is a flowchart illustrating a method 600 of prioritizing data transmissions according to an embodiment of the disclosure. The method 600 may be implemented in the drop point 250. At step 610, a plurality of instructions for prioritizing data transmissions may be received. The instructions may be gate messages, or window start times included in those gate messages, and the instructions may be received from the OLT 230. At step 620, the instructions may be processed. At step 630, the data transmissions may be received. The transmissions may be received from the CPEs₁₋ₙ 270₁₋ₙ. At step 640, the data transmissions may be transmitted based on the instructions. The drop point 250 may transmit the data transmissions to the OLT 230. The instructions may instruct prioritizing of the data transmissions so that one of the data transmissions with a shortest polling time is transmitted first. The instructions may further instruct prioritizing of the data transmissions so that one of the data transmissions with a longest polling time is transmitted last and so that data transmissions with a plurality of intermediate polling times are transmitted between the one of the data transmissions with a shortest polling time and the one of the data transmissions with a longest polling. The prioritizing may be based off of the equation 8 or the expression 9.

FIG. 7 is a schematic diagram of a computer system 700 according to an embodiment of the disclosure. The system 700 may be suitable for implementing the disclosed embodiments. The system 700 may comprise a processor 710 that is in communication with memory devices, including secondary storage 720, read only memory (ROM) 730, random access memory (RAM) 740, input/output (I/O) devices 750, and a transmitter/receiver 760. Although illustrated as a single processor, the processor 710 is not so limited and may comprise multiple processors. The processor 710 may be implemented as one or more central processor unit (CPU) chips, cores (e.g., a multi-core processor), field-programmable gate arrays (FPGAs), application specific integrated circuits (ASICs), and/or digital signal processors (DSPs), and/or may be part of one or more ASICs. The processor 710 may be implemented using hardware or a combination of hardware and software.

The secondary storage 720 may comprise one or more disk drives or tape drives and may be used for non-volatile storage of data and as an overflow data storage device if the RAM 740 is not large enough to hold all working data. The secondary storage 720 may be used to store programs that are loaded into the RAM 740 when such programs are selected for execution. The ROM 730 may be used to store instructions and data that are read during program execution. The ROM 730 may be a non-volatile memory device that may have a small memory capacity relative to the larger memory capacity of the secondary storage 720. The RAM 740 may be used to store volatile data and perhaps to store instructions. Access to both the ROM 730 and the RAM 740 may be faster than to the secondary storage 720.

The transmitter/receiver 760 may serve as an output and/or input device of the system 700. For example, if the transmitter/receiver 760 is acting as a transmitter, it may transmit data out of the system 700. If the transmitter/receiver 760 is acting as a receiver, it may receive data into the system 700. The transmitter/receiver 760 may take the form of modems; modem banks; Ethernet cards; universal serial bus (USB) interface cards; serial interfaces; token ring cards; fiber distributed data interface (FDDI) cards; wireless local area network (WLAN) cards; radio transceiver cards such as code division multiple access (CDMA), global system for mobile communications (GSM), long-term evolution (LTE), worldwide interoperability for microwave access (WiMAX), and/or other air interface protocol radio transceiver cards; and other well-known network devices. The transmitter/receiver 760 may enable the processor 710 to communicate with the Internet or one or more intranets. The I/O devices 750 may comprise a video monitor, liquid crystal display (LCD), touch screen display, or other type of video display for displaying video, and may also include a video recording device for capturing video. The I/O devices 750 may also include one or more keyboards, mice, track balls, or other well-known input devices.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a receiver configured to receive a plurality of instructions, a plurality of first messages, and a plurality of second messages;
a processor coupled to the receiver and configured to process the instructions, the first messages, and the second messages; and
a transmitter coupled to the processor and configured to transmit the second messages based on the instructions, wherein the instructions instruct the processor to transmit the second messages based on polling times.

2. The apparatus of claim 1, wherein the apparatus is a drop point comprising an optical network unit (ONU) and a digital subscriber line access multiplexer (DSLAM).

3. The apparatus of claim 1, wherein polling times are total times from initiation of polling signaling from an optical line terminal (OLT) to a time a first bit transmitted from the apparatus is received at the OLT.

4. The apparatus of claim 1, wherein the first messages are gate messages and the second messages are upstream transmission windows.

5. The apparatus of claim 4, wherein the receiver is configured to receive the instructions from an optical line terminal (OLT), receive the gate messages from the OLT, and receive the upstream transmission windows from customer premises equipments (CPEs), and wherein the transmitter is configured to transmit the upstream transmission windows to the OLT in an order starting with a CPE with a shortest polling time and ending with a CPE with a longest polling time.

6. The apparatus of claim 5, wherein the order is maintained for a granting cycle and subsequent orders are maintained for subsequent granting cycles.

7. The apparatus of claim 6, wherein the transmitter is further configured to transmit the upstream transmission windows based on a plurality of classes associated with the upstream transmission windows.

8. The apparatus of claim 7, wherein the classes comprise an emergency class and a non-emergency class.

9. The apparatus of claim 1, wherein the receiver is further configured to receive the instructions via a media access control (MAC) layer.

10. An apparatus comprising:
a processor configured to compile instructions, wherein the instructions instruct prioritizing of data transmissions based on propagation delays; and
a transmitter coupled to the processor and configured to transmit the instructions.

11. The apparatus of claim 10, wherein the apparatus is an optical line terminal (OLT).

12. The apparatus of claim 11, wherein the instructions further instruct prioritizing of the data transmissions based on grant window sizes and transmission rates.

13. The apparatus of claim 12, wherein the propagation delays are associated with delays between a drop point and customer premises equipments (CPEs), and wherein the transmission rates are associated with transmissions between the drop point and the CPEs.

14. The apparatus of claim 12, wherein each CPE is associated with the expression
$$2 {T}_{{P}_{i}}^{E} + \frac{{G}_{i}}{{R}_{E}^{up}} ,$$
wherein T_{P}_{ᵢ}^{E} is a propagation delay between the drop point and an ith CPE, Gᵢ is a grant window size for the ith CPE, and R_{E}^{up} is a transmission rate from the CPEs to the drop point, and wherein the data transmissions are prioritized in an ascending order according to the expression.

15. A method comprising:
receiving a plurality of instructions for prioritizing data transmissions;
processing the instructions;
receiving the data transmissions; and
transmitting the data transmissions based on the instructions, wherein the instructions instruct prioritizing of the data transmissions so that one of the data transmissions associated with a shortest polling time is transmitted first.

16. The method of claim 15, wherein the instructions further instruct prioritizing of the data transmissions so that one of the data transmissions associated with a longest polling time is transmitted last.

17. The method of claim 16, wherein the instructions further instruct prioritizing of the data transmissions so that data transmissions associated with a plurality of intermediate polling times are transmitted between the one of the data transmissions associated with a shortest polling time and the one of the data transmissions associated with a longest polling.

18. The method of claim 17, wherein the shortest polling time, the longest polling time, and the intermediate polling times are calculated based on the equation
$$T = ( 1 + n ) {T}_{G}^{O} + {T}_{G}^{E} + 2 {T}_{P}^{O} + {max}_{i = 1 - n} [ 2 {T}_{{P}_{i}}^{E} + \frac{{G}_{i}}{{R}_{E}^{up}} - \frac{{\sum }_{j = 1}^{i} {G}_{j}}{{R}_{O}^{up}} ] + \frac{{P}_{max}}{{R}_{O}^{up}} ,$$
wherein T is a polling time, n is a number of customer premises equipments (CPEs), T_{G}^{O} is a time to transmit a gate message from an optical line terminal (OLT) to a drop point, T_{G}^{E} is a time to transmit the gate message from the drop point to the CPEs, T_{P}^{O} is a propagation delay between the OLT and the drop point, T_{P}ᵢ^{E} is a propagation delay between the drop point and an ith CPE, Gᵢ is a grant window size for the ith CPE, R_{E}^{up} is a transmission rate from the CPEs to the drop point, Gⱼ is a grant window size for a jth CPE, R_{O}^{up} is a transmission rate from the drop point to the OLT, and Pₘₐₓ is a maximum packet size.

19. The method of claim 15, wherein the instructions are received via a media access control (MAC) layer.

20. The method of claim 15, wherein the data transmissions are response messages of a polling process.
